(19) United States
(12) Patent Application Publication
(10) Pub. No.: US 2008/0025049 A1
(43) Pub. Date: Jan. 31, 2008

(54) Wide Input Range Power Supply

(75) Inventor: Leonid Spindler, Lod (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: LV POWER LTD., Tzur Yigal (IL)

(21) Appl. No.: 11/459,648

(22) Filed: Jul. 25, 2006

(51) Int. Cl. H02J 1/00

(52) U.S. Cl. 363/15

(57) ABSTRACT

A series resonant converter (SRC) power supply with a wide input range and high efficiency is achieved by using both frequency control of the SRC and phase control of phase differences between a voltage signal inside the SRC and a voltage signal inside a synchronous/asynchronous rectifier coupled to the SRC. Preferably, the phase control is applied, alone or in combination with additional frequency control, after the phase difference reaches approximately 90 degrees and up to a phase difference of 180 degrees.

### FIELD OF THE INVENTION

The present invention relates to electrical power supplies (PS) and in particular to Series Resonant Converter (SRC) power supplies having a wide range of input voltages.

### BACKGROUND OF THE INVENTION

Modern power supplies based on pulse width modulation (PWM) are known. Some of these supplies have an input voltage (Vᵢₙ) range of 4 (e.g. 118-370 VDC or 86-264 VAC) and operate at conversion frequencies of 100-300 KHz. Exemplary applications that require the full input range include Compact PCI. Normally, such power supplies include separate ac/dc and dc/dc conversion modules. Attempts to get a wider input range are limited by the efficiency losses introduced by high frequency operation, see below.

The general architecture of existing power supplies is illustrated with the help of the block diagram of FIG. 1. FIG. 1 shows a typical PS 100 that includes an input block 102 typically having an input rectifier and an EMI filter (not shown), a series resonant converter (SRC) 104 for converting the low frequency pulsed dc voltage (or just regular input dc voltage) into a high frequency AC voltage, a synchronous/asynchronous rectifier 106 for converting the high frequency AC voltage into a dc voltage V ₒᵤₜ, a control unit 108 and an output block 110. Input block 102 is configured to receive a range of ac or dc input voltages, for example between 36-72 VDC or 84-264 VAC. The input rectifier (not shown) changes the ac input voltage to a pulsed dc voltage. The EMI filter (not shown) is required to meet industry standards on RFI EMI emissions. The magnitude of the SRC impedance Z is a function of its operating frequency. That is, low frequency=low impedance and high frequency=high impedance. The control unit preferably includes a frequency control module or function 112.

When the input voltage Vᵢₙ increases, the operating conversion frequency F increases as well. This causes the series impedance Z to increase, so the output voltage Vₒᵤₜ remains constant. The problem with the existing technology is that if Vᵢₙ changes by a factor of X then the operating frequency has to change by approximately the same factor X. Present technology allows the maximum variation in the input voltage range (and the variation in frequency) to vary by a factor of 2 (in the telecom input range from 36 VDC to 75 VDC) or by a factor of 4 (input voltages from 118 VDC to 370 VDC or 86 VAC to 264 VAC) in other uses. The reason for this is that current materials used in power conversion are optimized at an operating frequency of an average of 100-300 KHz. If the operating conversion frequency is much smaller than this, the component size, weight, and cost increase. If the operating frequency is much higher (say 1 Mhz), the size of the components in the PS decreases, but many other factors that increase losses become dominant. These include the skin effect, the proximity effect, the PWM resolution, dynamic losses, etc. Consequently, at such high frequencies, the PS losses would be in the range of 25-30%.

The change in F causes a relative change in the phases φ of the voltage inputs measured at the SRC and at the synchronous/asynchrononous rectifier. Specifically, increasing F causes an increasing phase difference or “shift” Δφ between the SRC and the input of rectifier 106. Δφ may vary from about 30 to 180 degrees. For example, a doubling of the original F typically causes a Δφ of up to 90 degrees. Once Δφ reaches 90 degrees, any further increase in F decreases the efficiency, so any further increase in F is counterproductive. This is the main reason why most power supplies limit the F changes to a maximum factor of about 4. The separate control of the voltage signal phase in a synchronous/asynchronous rectifier is known, and used for example in the so-called Class D Synchronous Rectifiers, see for example M. K. Kazimierczuk, IEEE Translations on Industrial Electronics, Vol. 38, No. 5, pp. 344-354, 1991 and M. Mikotaljewski, IEEE Transactions on Industrial Electronics, Vol. 38, No. 5, pp. 694-697, 1991, which are hereby incorporated herein by reference. While separate control of both frequency and phase of electrical components are known, the combined use of these two controls to affect the input range of a power supply that outputs a constant dc voltage in not known.

From the explanations above, it is clearly impractical under existing state of the art to have a variation of more than about 4 in operating frequencies of power supplies. TV plasma power supplies may have a change in operating frequency of 1:10, but this severly reduces their operating efficiency. The frequency limitation limits the input voltage range to about the same factor. It would therefore be extremely advantageous to have power supplies that can extend this range to much higher ranges, while at the same time ensuring high efficiencies.

### SUMMARY OF THE INVENTION

The present invention relates to a universal (both ac/dc and dc/dc), wide input range Series Resonant Converter (SRC) power supply with input voltage changes by a factor of 11 (i.e. the input range extends to 1:11) and high conversion efficiency (small losses). Inventively, and in contrast with prior art, the large Vᵢₙ range is enabled by the use of a much smaller operating frequency range (factor 2-3). Instead of requiring matching (to Vᵢₙ) F changes by a factor of 11, a PS of the present invention requires F changes only by a factor of 2-3 to maintain a constant Vₒᵤₜ. This is a reasonable change in operating frequency and easily accomplished.

The limitation of the use of a small F range to allow a large Vᵢₙ range requires an additional conversion control factor in the form of phase control. In the present invention, F is varied as a single control factor only up to the frequency for which there is a 90 degree change between the phase of the voltage at the SRC and the voltage of the synchronous/asynchronous rectifier. The change in F needed to reach this phase shift is typically a factor of about 2. After reaching the 90 degree phase change, the phase at the rectifier input is varied by up to another 90 degrees either solely by use of phase control, or by a combination of phase and frequency controls. The total change in the phase between the SRC voltage and the voltage on the rectifier is thus able to vary by a full 180 degree range, while the input frequency has been varied only by a 2-3 ratio. A full 180 degree change in phase can cause Vₒᵤₜ to vary all the way down to zero. In a preferred embodiment, this 180 degree variation in phase between SRC and rectifier voltage thus allows for a constant regulated voltage at the output while the input voltage is varied in amplitude by a ratio of 11, something unattainable with high efficiency in prior art.

According to the present invention there is provided a power supply including an input block operative to receive universal ac and dc input voltage signals in a given input voltage range and to output a pulsed rectified high dc voltage signal (or a dc voltage signal in the case of dc input), a series resonant converter (SRC) for receiving the pulsed rectified high dc voltage signal or the dc voltage signal and for outputting a corresponding high frequency ac voltage signal, a synchronous/asynchronous rectifier for converting the high frequency ac voltage signal into a set dc voltage and a control unit having a frequency control module and a phase control module, wherein both modules are used to ensure that the set output dc voltage remains substantially consistent upon changes of the input voltage signals over the input range.

According to one feature of the system, the phase control module is operative to control a phase difference between the corresponding high frequency ac voltage signal in the SRC and a corresponding high frequency ac voltage signal in the synchronous/asynchronous rectifier when the phase difference exceeds a certain value.

According to another feature of the system, the given input voltage range extends to 1:11.

According to yet another feature of the system, the frequency control module is operative to increase the corresponding high frequency by a factor of up to 2 for phase differences of up to 90 degrees.

According to the present invention there is provided a method for power conversion in a power supply with a wide input range including steps of: providing a power supply that includes an input block operative to receive universal ac and dc input voltages in a given input voltage range and for outputting a pulsed rectified high dc voltage signal (or a dc voltage signal in the case of dc input), a SRC receiving from the input block the dc voltage signal and for outputting a corresponding high frequency ac voltage, a synchronous/asynchronous rectifier for converting the high frequency as voltage into a set dc output voltage and a control unit have a frequency control module and a phase control module; and using both frequency control and phase control to keep the set dc output voltage substantially constant upon changes of the input voltage over the input range.

According to one aspect of the method for power conversion in a power supply with a wide input range, the step of using both frequency control and phase control includes using the frequency control to control a phase difference between the SRC and the synchronous/asynchronous rectifier before the phase difference reaches a certain value and using the phase control to control the phase difference between the SRC and the synchronous/asynchronous rectifier when the phase difference exceeds the certain value.

According to the present invention there is provided a method for power conversion in a power supply with a wide input range, the power supply including a SRC connected to a synchronous/asynchronous rectifier, the method including steps of using frequency control to keep a set output dc voltage constant while a phase difference of voltage signal phases in the SRC and the synchronous/asynchronous rectifier is lower than a predetermined value and using at least a phase control to keep the set output dc voltage constant when the phase difference between the voltage signal phases exceeds the predetermined value, thereby achieving high efficiency over a wide given input voltage range.

### BRIEF DESCRIPTION OF THE DRAWINGS

The invention is herein described, by way of example only, with reference to the accompanying drawings, wherein:

FIG. 1 shows schematically a prior art Series Resonant Converter (SRC) power supply;

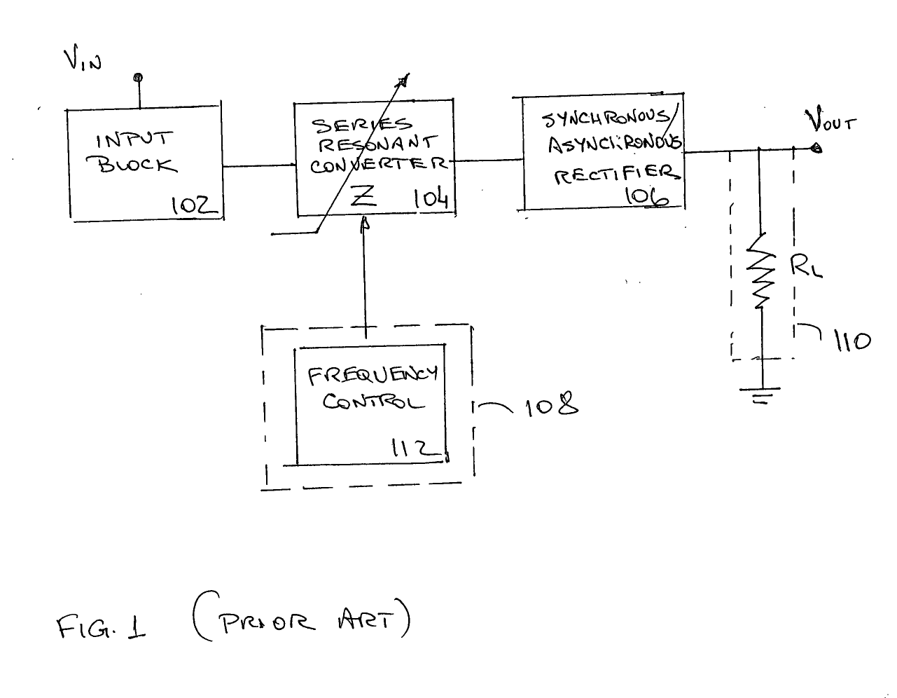

FIG. 2 shows schematically a phase controlled SRC power supply of the present invention;

FIG. 3 shows voltage and current waveforms through the SRC and synchronous/asynchronous rectifier of the PS of FIG. 2.

### DETAILED DESCRIPTION OF THE PREFERRED EMBODIMENTS

The present invention relates to power supplies that have a wide voltage input range that accommodates both ac and dc signals. Exemplarily, and in contrast with prior art, a PS of the present invention can have an input ranging from 22 to 264 VAC or 32 to 370 VDC. The output of the PS can be set to a much lower dc voltage, exemplarily 12 VDC.

In order to accommodate such a wide input range of voltages and execute the conversion with a high efficiency, the present invention advantageously uses phase control in addition to frequency control. This inventive aspect will be better understood through the detailed description.

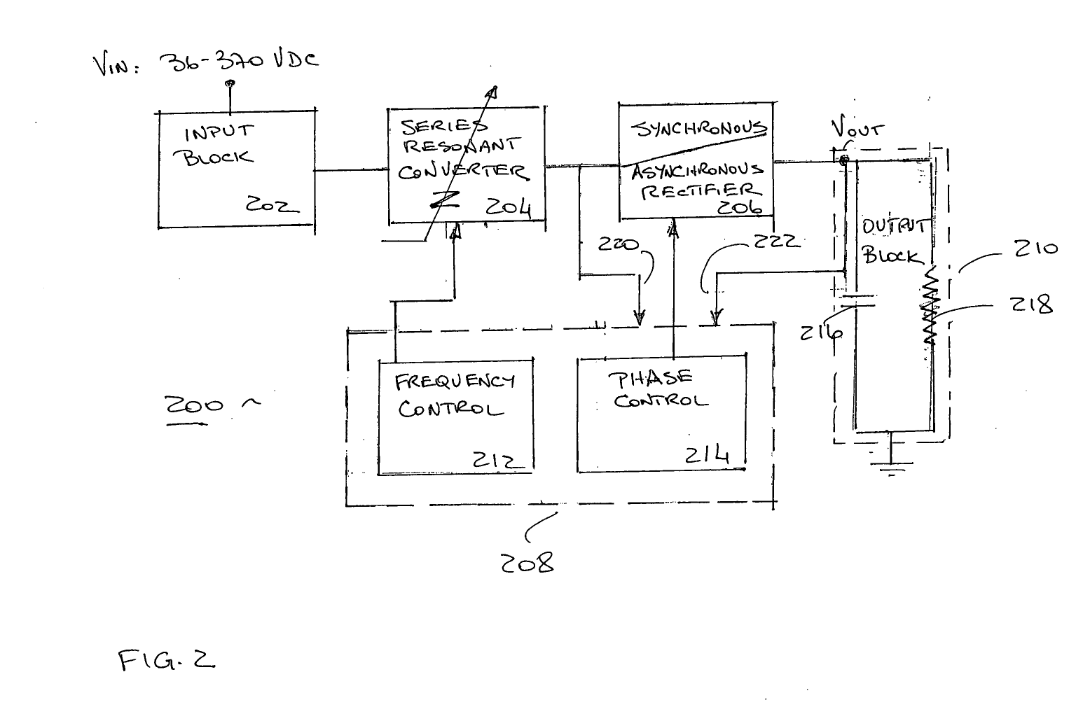

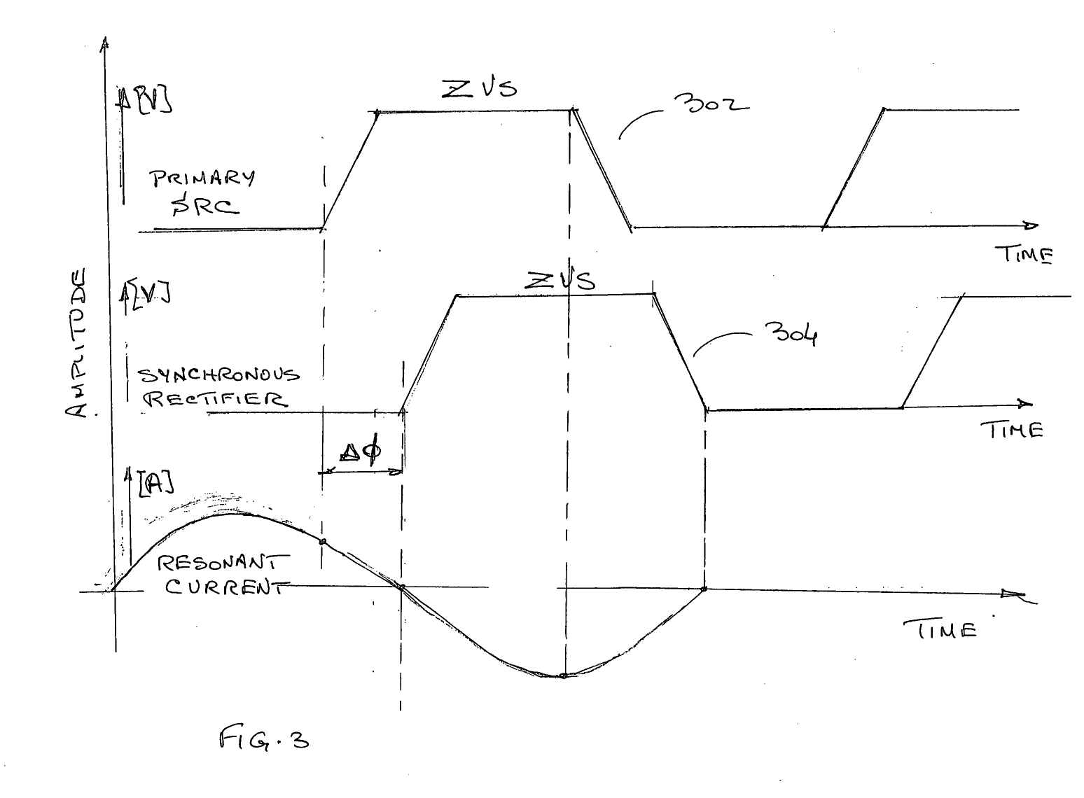

FIG. 2 shows a power supply system 200 of the present invention, with various elements interconnected as shown. FIG. 3 shows voltage and current waveforms through the SRC and synchronous/asynchronous rectifier of the PS of FIG. 2. In FIG. 2, PS system 200 includes an input block 202 typically having an input rectifier and an LMI filter (not shown) operative to receive an input voltage with a voltage Vin and to output a pulsed rectified high dc voltage (or a constant DC voltage); a series resonant converter (SRC) 204 for converting the pulsed rectified high dc voltage into a high frequency AC voltage (typically 100-300 KHz); a synchronous/asynchronous rectifier 206 for converting the high frequency AC voltage into an equal dc voltage Vₒᵤₜ; a control unit 208 and an output block 210. Input block 202 is configured to receive a wide range of ac and dc input voltages, for example between 36 and 370 VDC (or equivalently 22-264 VAC). AC voltages are normally input at line frequences i.e. 50-60 Hz. The control unit preferably includes a frequency control module or function 212 and a phase control module or function 214. It may be implemented in a single digital signal processor (DSP) module or chip. An exemplary DSP module that can serve as unit 208 is component TMS320F2806 from Texas Instruments. Module 212 is operative to control the frequency of a voltage signal 302 (FIG. 3) through SRC 204 and module 214 is operative to control the phase of a voltage signal 304 (FIG. 3) through rectifier 206. The output block typically includes a parallel connection of a load capacitor 216 and a load resistor 218, and is configured to output a substantially constant regulated low voltage, typically between 1-48 VDC. Arrows 220 and 222 represent respectively feedbacks of non-rectified and rectified voltage signals before and after rectifier 206, which are input to control unit 208.

In use, the low input frequency as voltage signal is converted into a rectified high dc voltage signal (or if a dc input, transmitted without change) and input to SRC 204, where it is converted further into a high frequency ac voltage signal. The high frequency ac voltage signal has a peak amplitude of Vᵢₙ at typically 100-300 KHz. This signal is then input to synchronous/asynchronous rectifier 206, which rectifies it to Vₒᵤₜ. Note that the phase difference Δφ refers to the phases of these two high frequency ac signals (in the SRC and synchronous/asynchronous rectifier) Vₒᵤₜ is selected to be at a constant dc value (e.g. 12V). Vₒᵤₜ is checked constantly and, if Vᵢₙ changes, actions are performed to keep Vₒᵤₜ constant.

Assume exemplarily that Vᵢₙ increases. As in all resonant converter power supplies, F is now increased, causing the series impedance Z series to increase, thus lowering the output voltage to the set constant Vₒᵤₜ. However, the increase in F also increases the Δφ between the voltage signals in the SRC and in rectifier 206. As long as Δφ≦90 degrees, this “F control” works as in prior art power supplies, and the necessary change in F is limited to about a factor of 2. For a Δφ between ca.30-90 degrees, rectifier 206 is in synchronous mode (i.e. the PS is in “synchronous rectifier” mode). For 90−Δφ≦180 rectifier 206 is in asynchronous mode (i.e. the PS is in “asynchronous rectifier” mode).

Inventively and in contrast with prior art, in one embodiment of the present invention, when Δφ>90 (and up to 180 degrees), further increases in the Vᵢₙ magnitude are accommodated in the PS of the present invention solely by phase control changes applied to rectifier 206. In another embodiment when Δφ>90, further increases in Vᵢₙ are accommodated in the PS of the present invention either by phase control changes applied to rectifier 206 in combination with further frequency control. The phase control of the synchronous/asynchronous rectifier may be performed for example as described in M. K. Kazimierczuk, IEEE Transactions on Industrial Electronics, Vol. 38, No. 5, pp. 344-354, 1991 and M. Mikotajewski, IEEE Transactions on Industrial Electronics, Vol. 38, No. 5, pp. 694-697, 1991, which are hereby incorporated herein by reference. In both embodiments (phase control alone or combined phase and frequency control), the phase control works in the same direction as the F control, i.e. to shift the phase in the rectifier to higher values. Application of phase control together with F control allows faster adjustment of Vₒᵤₜ to Vᵢₙ changes.

The full or partial replacement of frequency control by phase control when 90≦Δφ≦180 degrees is a key inventive feature of the present invention, which allows the Vᵢₙ range to be much wider (up to 11) than in existing power supplies without sacrificing efficiency by increasing F. The efficiency remains high because the F swing is limited to about 2. The power supply of the present invention is universal, accommodating both ac and dc inputs.

All publications mentioned in this specification are herein incorporated in their entirety by reference into the specification, to the same extent as if each individual publication was specifically and individually indicated to be incorporated herein by reference. In addition, citation or identification of any reference in this application shall not be construed as an admission that such reference is available as prior art to the present invention.

What is claimed is:

1. A power supply comprising:
a. an input block operative to receive both alternating current (ac) and direct current (dc) input voltage signals in a given input voltage range and to output a dc voltage signal;
b. a series resonant converter (SRC) for receiving the dc voltage signal from the input block and for outputting a corresponding high frequency ac voltage signal;
c. a synchronous/asynchronous rectifier for converting the high frequency ac voltage signal into a dc voltage; and
d. a control unit having a frequency control module and a phase control module, wherein both modules are used to ensure that the set output dc voltage remains substantially constant upon changes of the input voltage signals over the input range;
whereby the power supply is universal and can accommodate a wide range of both ac and dc voltage inputs.

2. The system of claim 1, wherein the phase control module is operative to control a phase difference between the high frequency ac voltage signal in the SRC and a corresponding high frequency ac voltage signal in the synchronous/asynchronous rectifier when the phase difference exceeds a certain value.

3. The system of claim 2, wherein the given input voltage range extends to 1:11.

4. The system of claim 3, wherein the certain value equals about 90 degrees.

5. The system of claim 1, further comprising an output block operative to output the set dc voltage to a load.

6. The system of claim 1, wherein the control unit is implemented in a single integrated chip.

7. The system of claim 4, wherein the frequency control module is operative to increase the corresponding high frequency by a factor of up to 2 for phase differences of up to 90 degrees.

8. The system of claim 6, wherein the integrated chip is a digital signal processor (DSP) chip.

9. A method for power conversion in a power supply with a wide input range comprising steps of:
a. providing a power supply that includes:
i. an input block operative to receive universal alternating current (ac) and direct current (dc) input voltages in a given input voltage range and to output a dc voltage signal;
ii. a series resonant converter (SRC) for receiving the pulsed rectified high dc voltage signal from the input block and for outputting a corresponding high frequency ac voltage;
iii. a synchronous/asynchronous rectifier for converting the high frequency ac voltage into a set dc output voltage; and
iv. a control unit having a frequency control module and a phase control module; and
b. using both frequency control and phase control to keep the set dc output voltage substantially constant upon changes of the input voltage over the input range.

10. The method of claim 9, wherein the step of using both frequency control and phase control includes:
i. using the frequency control to control a phase difference between the SRC and the synchronous/asynchronous rectifier before the phase difference reaches a certain value and
ii. using the phase control to control the phase difference between the SRC and the synchronous/asynchronous rectifier when the phase difference exceeds the certain value.

11. The method of claim 10, wherein the certain value equals about 90 degrees.

12. The method of claim 9, wherein the given input voltage range extends to 1:11.

13. A method for power conversion in a power supply with a wide input range, the power supply including a series resonant converter (SRC) connected to a synchronous/asynchronous rectifier, the method comprising steps of:
a. using a frequency control to keep a set output dc voltage constant while a phase difference of voltage signal phases in the SRC and the synchronous/asynchronous rectifier is lower than a predetermined value; and
b. using at least a phase control to keep the set output dc voltage constant when the phase difference between the voltage signal phases exceeds the predetermined value, thereby achieving high efficiency over a wide given input voltage range.

14. The method of claim 13, wherein the step of using at least a phase control includes using solely the phase control.

15. The method of claim 13, wherein the step of using at least a phase control includes using the phase control in combination with a frequency control.

16. The method of claim 13, wherein the step of using at least a phase control includes using the phase control to change the phase of a voltage signal in the synchronous/asynchronous rectifier relative to the phase of a voltage signal in the SRC.

17. The method of claim 13, wherein the step of using a frequency control includes applying the control to change an impedance of the SRC.

18. The method of claim 15, wherein the step of using a using a phase control in combination with a frequency control includes using the frequency control to change an impedance of the SRC and the phase control to change the phase of a voltage signal in the synchronous/asynchronous rectifier relative to the phase of a voltage signal in the SRC.

19. The method of claim 13, wherein the predetermined phase difference value is about 90 degrees.

20. The method of claim 13, wherein the given input voltage range extends to 1:11.
